(19) United States
(12) Patent Application Publication
(10) Pub. No.: US 2004/0258230 A1
(43) Pub. Date: Dec. 23, 2004

(54) Method and apparatus for making a long distance telephone call

(76) Inventor: George Barry Hanna, Marietta, GA (US)

Correspondence Address: CANTOR COLBURN LLP, 55 GRIFFIN ROAD SOUTH, BLOOMFIELD, CT, 06002, US

(21) Appl. No.: 10/717,689

(22) Filed: Nov. 20, 2003

Related U.S. Application Data
(63) Continuation-in-part of application No. 10/600,193, filed on Jun. 19, 2003.

(51) Int. Cl. H04M 15/00; H04M 3/42

(52) U.S. Cl. 379/121.02; 379/202.01

(57) ABSTRACT

A method for making a telephone call connection is disclosed. An incoming call is received at a computer in signal communication with a telephone being called. The telephone has an associated sign-up calling plan service billed to a home plan at a home plan rate. In response to the caller replying to a computerized service announcement and requesting that an outgoing call be made, the caller is prompted to enter a personal identification number. In response to the personal identification number being validated, and in response to the caller replying to another computerized service announcement and entering a long distance or international destination telephone number to be called, an outbound call is invoked to the destination number. In response to the destination number being answered, the computer drops off line thereby enabling the caller to communicate with the destination number via the home plan at the home plan rate.

### CROSS REFERENCE TO RELATED APPLICATIONS

This application is a continuation-in-part of U.S. application Ser. No. 10/600,193, filed Jun. 19, 2003, which is incorporated herein by reference in its entirety.

### FIELD OF THE INVENTION

The present disclosure relates generally to a method and apparatus for making a long distance telephone call, and particularly to a method and apparatus for making long distance or international telephone calls from a remote phone and having the call billed to a home plan phone bill at the home plan rates.

### BACKGROUND OF THE INVENTION

Long distance telephone calling plans are available from long distance carriers and include such arrangements as service provider home billing plans, service provider calling card plans, and third party calling card plans, for example. Service provider home billing plans provide for long distance calling from a home phone that is billed to a home plan, but do not provide for long distance calling from a phone other than a home phone at the home plan rates. Service provider calling card plans provide for long distance calling from a remote location that is billed to a home plan, but do not provide for long distance calling through a toll-free access line at the home plan rates. Third party calling card plans provide for long distance calling from any location on a pre-paid basis, but do not provide for billing to a home plan at the home plan rates. Accordingly, there is a need in the art for a long distance calling plan that provides for remote access at low rates.

### SUMMARY OF THE INVENTION

Embodiments of the invention include a method for making a telephone call connection. An incoming call is received at a computer in signal communication with a telephone being called by a caller. The telephone has an associated sign-up-calling plan service billed to a home plan at a home plan rate. The caller is prompted with a first service announcement. In response to the caller replying to the first service announcement and requesting that an outgoing call be made, the caller is prompted to enter a personal identification number. In response to the personal identification number being validated, the caller is prompted with a second service announcement. In response to the caller replying to the second service announcement and entering a long distance or international destination telephone number to be called, an outbound call is invoked to the destination number, and in response to the destination number being answered, the computer drops off line, thereby enabling the caller to communicate with the destination number via the home plan at the home plan rate.

Other embodiments of the invention include a computer program product for implementing the method described above.

Further embodiments of the invention include a specialized computer in signal communication with a telephone and adapted for implementing the method described above.

### BRIEF DESCRIPTION OF THE DRAWINGS

Referring to the exemplary drawings wherein like elements are numbered alike:

FIG. 1 depicts an exemplary sign-up calling plan service architecture in accordance with an embodiment of the invention; and

FIG. 2 depicts an exemplary alternative sign-up calling plan service architecture to that of FIG. 1 with some detail of FIG. 1 omitted for clarity.

### DETAILED DESCRIPTION OF THE INVENTION

An embodiment of the present invention provides a method for making long distance and international telephone calls from a remote phone or cell phone using a sign-up calling plan and having the call billed on the caller's (subscriber's) home plan phone bill at the home plan rates. As used herein, the term home plan refers to the telephone service covering the subscriber's telephones, which may be residence or business telephones. The sign-up calling plan may be a home long distance calling plan, a calling card plan, or a toll-free calling plan, and while reference is made herein to a sign-up calling plan generally, it will be appreciated that any of the aforementioned sign-up calling plans may be used. With regard to a sign-up calling plan service being billed to a subscriber's home plan, the subscriber may choose to pre-purchase buckets of sign-up calling plan minutes or sign up for a perpetual per-minute rate. With either arrangement, billable usage is added to and included on the home plan bill.

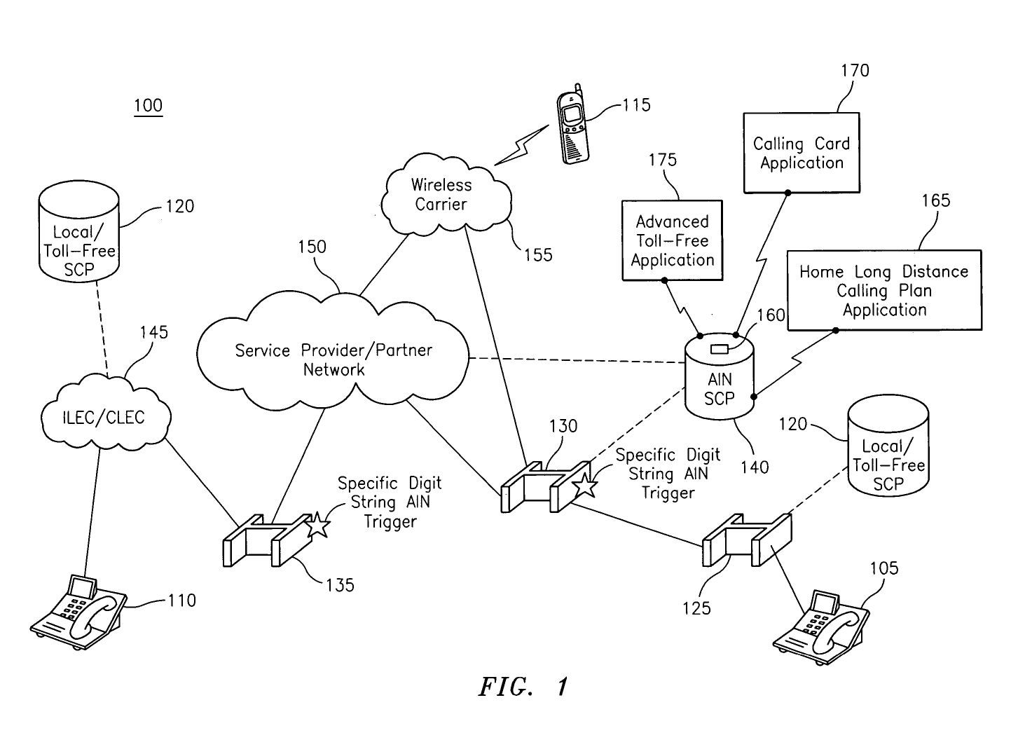

FIG. 1 depicts an exemplary embodiment of a home long distance calling plan service architecture (service architecture) 100, which includes remote telephones 105, 110, 115, local toll-free service control points (LTF SCP) 120, an originating service switching point (SSP) 125, a service provider SSP 130, a partner SSP 135, an advanced intelligent network service control point (AIN SCP) 140, a local exchange carrier (LEC) network 145 (alternatively referred to as Incumbent LEC (ILEC) and Competitive LEC (CLEC) network), a service provider/partner network 150, and a wireless carrier network 155. AIN SCP 140 includes a processor 160, which is programmed to access a customer database containing calling plan application information 165, 170, 175, discussed further below. Remote telephones 105, 110, 115 may be landline or cellular telephones, and refer generally to any telephone that is other than the caller's home telephone. As used herein, the term cellular telephone is intended to refer to any wireless telephone. As depicted, remote telephones 105, 110 are landline telephones in signal communication with originating SSP 125 and LEC network 145, respectively, and 115 is a cellular telephone in signal communication with wireless carrier network 155. While SSPs 125, 130, 135 are referred to as originating SSP, service provider SSP, and partner SSP, respectively, it will be appreciated that these labels are exemplary only and that other embodiments may use other SSP arrangements.

In an exemplary embodiment, when a caller wishes to place a long distance or international call using a sign-up calling plan, the caller first calls a plan-assigned telephone number, such as a toll-free 1-800-xxx-xxxx number for example, from a remote phone 105, which provides the caller with access to the subscribed sign-up calling plan service. Accessing the sign-up calling plan service through a toll-free access line enables the caller to place a long-distance call without invoking long-distance calling charges. The call placed at remote phone 105 is received at originating SSP 125, which sends a query to LTF SCP 120 for carrier information. In response to this query, originating SSP 125 receives a carrier ID (identifier) that identifies a service provider associated with and servicing the caller's call, and routes the call to service provider SSP 130. At service provider SSP 130, an AIN Specific Digit String (SDS) trigger is encountered that identifies a SCP servicing the sign-up calling plan. In an embodiment, service provider SSP 130 encounters an AIN SDS trigger when the appropriate sequence of digits is dialed. For example, the trigger may be set on any of the following sequence of dialed digits: NPA (Numbering Plan Area code), NPAN, NPANX, NPANXX, NPANXXX, NPANXXXX, NPANXXXXX, NPANXXXXXX. In other words, service provider SSP 130 will detect the SDS trigger if the called party ID matches a specific code, which may be from 3 to 10 digits. Triggers detected on a more specific code take precedence over triggers detected on a less specific code. In an exemplary embodiment, the SDS trigger is set on the ten-digit (800) number that the calling party dials. When service provider SSP 130 receives a call with the called party identification that matches the specific (800) number assigned to the subscriber's Home Long Distance Calling Plan, an SDS trigger is fired and service provider SSP 130 sends a call-related query to AIN SCP 140. AIN SCP 140, where the sign-up calling plan applications (home long distance calling plan application 165, calling card application 170, and toll-free calling plan application 175) reside, returns an instruction to prompt the caller to input their home telephone number and their personal identification number (PIN). In an alternative embodiment, service provider SSP 130 also receives in return an instruction to prompt the caller to input a selection identifying which sign-up calling plan the call should be billed to. In response to these requests, the caller inputs the requested information, thereby validating the caller as being an authorized user of the sign-up calling plan and setting up appropriate billing information. In response to the caller input, service provider SSP 130 communicates the caller input to AIN SCP 140, which accesses a customer database and retrieves the caller's sign-up calling plan. AIN SCP 140 then instructs service provider SSP 130 to play an announcement such as, “to place a call in the US or Canada, please press 1, to place an international call, please press 2”, and then to prompt the caller to input the telephone number to be called, which the caller responds to by inputting the requested information. Armed with caller information, plan information, and desired call information, AIN SCP 140 checks the caller's sign-up calling plan to determine whether the caller is authorized to make the call. If the call is authorized, AIN SCP 140 sends a message to service provider SSP 130 that contains call information and billing information relating to the caller's sign-up calling plan. Service provider SSP 130 then routes the call to the desired location and generates a billing call record for inclusion on the caller's sign-up calling plan bill. If the call is not authorized, AIN SCP 140 instructs service provider SSP 130 to play an announcement to inform the caller that the call cannot be completed and to provide the reason why not.

In an embodiment, processor 160 at AIN SCP 140 includes programmed instructions for accessing a customer database, depicted generally at 165, 170, 175, to retrieve a caller's sign-up calling plan in response to a caller placing a call from a telephone 105 other than the caller's home telephone to access the caller's sign-up calling plan service, checking the caller's sign-up calling plan for authorization to complete the call in view of information input by the caller during the call, authorizing the call, and sending to service provider SSP 130 a message containing call information and billing information relating to the caller's sign-up calling plan.

Remote telephone 105 is representative of a telephone in signal communication with service provider SSP 130 and AIN SCP 140 via a service provider SSP 125; remote telephone 110 is representative of a telephone in signal communication with service provider SSP 130 and AIN SCP 140 via a local exchange carrier network 145, a partner SSP 135, and a service provider/partner network 150; and, cellular telephone 115 is representative of a telephone in signal communication with service provider SSP 130 and AIN SCP 140 via a wireless carrier network 155, and a service provider/partner network 150. In alternative embodiments, the caller may place a call to the subscribed sign-up calling plan service using either remote telephone 105, as discussed above, remote telephone 110, or cellular telephone 115. With regard to remote telephone 110 and cellular telephone 115 being points of origin of a subscriber call, signal communication to service provider SSP 130 follows standard telephone system practices and procedures. However, when a subscriber places a call to a sign-up calling plan service for the purpose of making a long distance or international call and having the call billed to the sign-up calling plan, communication between service provider SSP 130 and the point of origin is controlled by AIN SCP 140 and the programming at processor 160 as herein described and disclosed.

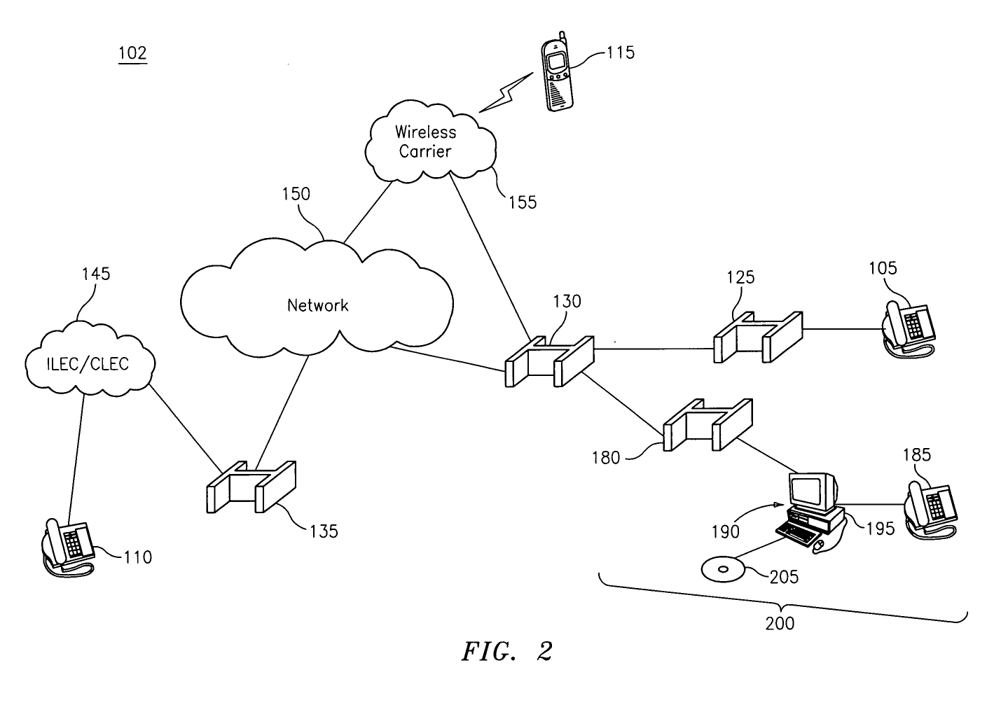

Referring now to FIG. 2, an alternative exemplary embodiment of a home long distance calling plan service architecture (service architecture) is depicted, with service architecture 100 of FIG. 1 being replaced by service architecture 102. While elements of service architecture 100 of FIG. 1 are omitted from service architecture 102 of FIG. 2 for clarity, it will be appreciated that service architectures 100 and 102 are exemplary only and that other service architectural elements may be included or excluded as appropriate. In an embodiment, service architecture 102 differs from service architecture 100 by the inclusion of signal path 200 that includes a central office SSP 180, a home-based phone (home phone) 185, and a computer 190 in signal communication with home phone 185 and arranged to receive incoming calls to home phone 185. As used herein, the term home phone refers to the caller's (subscriber's) telephones, which may be residence or business telephones. Computer 190 includes a processing circuit 195 operable in response to executable instructions on a storage medium 205, such as a CD-ROM or other suitable storage medium for example, for making a telephone call connection, which will be described in more detail below. The executable instructions on storage medium 205 are also referred to as application software, which may be run from CD-ROM 205 or may be loaded onto computer 190 and run locally.

In an exemplary embodiment, a caller who wishes to make a long distance or international telephone call to phone 110, for example, from a phone other than the caller's (subscriber's) home phone 185 and have the call billed to the caller's home plan, may use any remote phone, such as remote phone 105 or 115 for example, to first call the caller's home phone 185 and access computer 190, which includes the application software for intercepting incoming calls and managing an outgoing call connection. Upon receiving an incoming call at computer 190, the application software intercepts the call and prompts the caller with a first service announcement, such as “press 1 to speak to Ann, press 2 to make a call, press 3 to activate call-forwarding” for example. In response to the caller replying to the first service announcement by requesting that an outgoing call be made (selection 2), the application software prompts the caller to enter a personal identification number (PIN) in order to verify that the caller is authorized to make the call and to have the call billed to the associated home plan. In response to a validation of the caller's PIN, the application software prompts the caller with a second service announcement, such as “press 1 to enter a destination telephone number, press 2 to initiate a conference call” for example. In response to the caller replying to the second service announcement by selecting option “1”, the application software prompts the caller to enter the destination number. Upon entry of the destination number, which may be concluded by a time-out delay or the entry of a control key such as the “#” key for example, the application software invokes an outbound call to the destination number, and in response to the destination number being answered, the application software drops the computer off line, thereby enabling the caller to communicate with the destination number via the home plan at the home plan rate.

While only three menu options are illustrated for the first service announcement and only two menu options are illustrated for the second service announcement, it will be appreciated that other menu options may be included as desired.

In response to the destination number being busy, the application software may query the caller as to whether a call-back service should be activated, and in response to an affirmative reply from the caller, the application software activates the call-back service, thereby enabling the caller to communicate with the destination number via the home plan at the home plan rate when the destination number is not busy.

In response to the caller replying to the first service announcement by selecting option “1”, thereby requesting that the incoming call be answered locally at home phone 185, the application software directs the incoming call to home phone 185, which in turn activates a phone call signalling mechanism, such as a ringer for example.

In response to an outgoing call being made and where home phone 185 is serviced by only one phone line, the application software transmits an outbound signal similar to a hook-flash to invoke a three-way call between computer 190, the caller, and the destination telephone number. Where home phone 185 is serviced by more than one phone line, the application software sets up an outbound call on a second line, or port, and hairpins the call until it is disconnected.

In response to the caller replying to the second service announcement by selecting option “2” to initiate a conference call, the application software prompts the caller to enter the conference call telephone numbers to be called. Upon entry of the conference call numbers, which may be separated by a control key such as the “*” key for example and concluded by a time-out delay or the entry of a control key such as the “#” key for example, the application software invokes a conference call between computer 190, the caller, and each of the plurality of conference telephone numbers, and in response to the conference call connections being made or terminated, the application software drops the computer off line, thereby enabling the caller to communicate with the plurality of conference telephone numbers via the home plan at the home plan rate.

In response to the caller replying to the first service announcement by selecting option “3” to activate call-forwarding, the application software prompts the caller to enter the call-forward telephone number. Upon entry of the call-forward number, which may be concluded by a time-out delay or the entry of a control key such as the “#” key for example, the application software invokes call-forwarding, thereby redirecting all incoming calls received at computer 190 to the entered call-forward telephone number.

As described, the present invention may be embodied in the form of computer-implemented processes and apparatuses for practicing those processes. The present invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits.

The technical effect of the executable instructions is to establish a call connection such that a call made to a destination phone, such as a long distance or international call for example, may be made from a remote phone through a home phone on a home plan at a home plan rate.

Some embodiments of the invention may include some of the following advantages: remote access to buckets of minutes or low cost calling plan rates purchased from a long distance service provider and billed to a home plan; avoiding the need to have someone at home place a three-way long distance or international call with the remote subscriber being one of the parties; increased landline traffic and revenue generation for owners of landlines; remote access to home calling plan through subscriber's home telephone; and, remote access to telephone service features available on the home plan.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for making a telephone call connection, comprising:
receiving an incoming call at a computer in signal communication with a telephone being called by a caller, the telephone having an associated sign-up calling plan service billed to a home plan at a home plan rate;
prompting the caller with a first service announcement;
in response to the caller replying to the first service announcement and requesting that an outgoing call be made, prompting the caller to enter a personal identification number;
validating the personal identification number and prompting the caller with a second service announcement; and
in response to the caller replying to the second service announcement and entering a long distance or international destination telephone number to be called, invoking an outbound call to the destination number, and in response to the destination number being answered, dropping the computer off line, thereby enabling the caller to communicate with the destination number via the home plan at the home plan rate.

2. The method of claim 1, wherein the invoking an outbound call comprises:
in response to the telephone being serviced by only one line, invoking a three-way call between the computer, the caller, and the destination telephone number.

3. The method of claim 1, wherein the invoking an outbound call comprises:
in response to the telephone being serviced by more than one line, invoking an outbound call to the destination number on another line.

4. The method of claim 1, further comprising:
in response to the caller replying to the second service announcement and entering a plurality of conference call telephone numbers to be called, invoking a conference call between the computer, the caller, and each of the plurality of telephone numbers, and in response to the conference call connections being made or terminated, dropping the computer off line, thereby enabling the caller to communicate with the plurality of telephone numbers via the home plan at the home plan rate.

5. The method of claim 1, further comprising:
in response to the caller replying to the first service announcement and entering a call-forward command and a call-forward telephone number, redirecting all calls received at the computer to the call-forward telephone number.

6. The method of claim 1, further comprising:
in response to the destination number being busy and in response to a prompt from the caller, activating a call-back service, thereby enabling the caller to communicate with the destination number via the home plan at the home plan rate in response to the destination number not being busy.

7. The method of claim 1, further comprising:
in response to the caller replying to the first service announcement and requesting that the incoming call be answered, directing the incoming call to the telephone in signal communication with the computer.

8. The method of claim 1, wherein the telephone is the caller's residence telephone.

9. The method of claim 1, wherein the telephone is associated with the caller's place of business.

10. A computer program product for making a telephone call connection, the product comprising:
a storage medium, readable by a processing circuit, storing instructions for execution by the processing circuit for:
receiving an incoming call directed to a telephone being called by a caller, the telephone having an associated sign-up calling plan service billed to a home plan at a home plan rate;
prompting the caller with a first service announcement;
in response to the caller replying to the first service announcement and requesting that an outgoing call be made, prompting the caller to enter a personal identification number;
validating the personal identification number and prompting the caller with a second service announcement; and
in response to the caller replying to the second service announcement and entering a long distance or international destination telephone number to be called, invoking an outbound call to the destination number, and in response to the destination number being answered, disconnecting the processing circuit from the call, thereby enabling the caller to communicate with the destination number via the home plan at the home plan rate.

11. The product of claim 10, wherein the a storage medium further stores instructions for execution by the processing circuit for:
in response to the caller replying to the first service announcement and requesting that the incoming call be answered, directing the incoming call to the telephone being called.

12. The product of claim 10, wherein the a storage medium further stores instructions for execution by the processing circuit for:
invoking a three-way call between a computer, the caller, and the destination telephone number in response to the telephone being serviced by only one line, or invoking an outbound call to the destination number on another line in response to the telephone being serviced by more than one line.

13. The product of claim 10, wherein the a storage medium further stores instructions for execution by the processing circuit for performing at least one of:
in response to the caller replying to the second service announcement and entering a plurality of conference call telephone numbers to be called, invoking a conference call between a computer, the caller, and each of the plurality of telephone numbers, and in response to the conference call connections being made or terminated, dropping the computer off line, thereby enabling the caller to communicate with the plurality of telephone numbers via the home plan at the home plan rate;
in response to the caller replying to the first service announcement and entering a call-forward command and a call-forward telephone number, redirecting all incoming calls to the call-forward telephone number; and
in response to the destination number being busy and in response to a prompt from the caller, activating a call-back service, thereby enabling the caller to communicate with the destination number via the home plan at the home plan rate in response to the destination number not being busy.

14. A specialized computer in signal communication with a telephone and for making a telephone call connection, the computer comprising a processing circuit operable in response to executable instructions for:
receiving an incoming call directed to the telephone being called by a caller, the telephone having an associated sign-up calling plan service billed to a home plan at a home plan rate;
prompting the caller with a first service announcement;
in response to the caller replying to the first service announcement and requesting that an outgoing call be made, prompting the caller to enter a personal identification number;
validating the personal identification number and prompting the caller with a second service announcement; and
in response to the caller replying to the second service announcement and entering a long distance or international destination telephone number to be called, invoking an outbound call to the destination number, and in response to the destination number being answered, disconnecting the computer from the call, thereby enabling the caller to communicate with the destination number via the home plan at the home plan rate.

15. The specialized computer of claim 14, wherein the processing circuit is further operable in response to executable instructions for:
in response to the caller replying to the first service announcement and requesting that the incoming call be answered, directing the incoming call to the telephone being called.

16. The specialized computer of claim 14, wherein the processing circuit is further operable in response to executable instructions for:
invoking a three-way call between the computer, the caller, and the destination telephone number in response to the telephone being serviced by only one line, or invoking an outbound call to the destination number on another line in response to the telephone being serviced by more than one line.

17. The specialized computer of claim 14, wherein the processing circuit is further operable in response to executable instructions for performing at least one of:
in response to the caller replying to the second service announcement and entering a plurality of conference call telephone numbers to be called, invoking a conference call between the computer, the caller, and each of the plurality of telephone numbers, and in response to the conference call connections being made or terminated, dropping the computer off line, thereby enabling the caller to communicate with the plurality of telephone numbers via the home plan at the home plan rate;
in response to the caller replying to the first service announcement and entering a call-forward command and a call-forward telephone number, redirecting all incoming calls to the call-forward telephone number; and
in response to the destination number being busy and in response to a prompt from the caller, activating a call-back service, thereby enabling the caller to communicate with the destination number via the home plan at the home plan rate in response to the destination number not being busy.
